(19) United States
(12) Patent Application Publication
(10) Pub. No.: US 2025/0085977 A1
(43) Pub. Date: Mar. 13, 2025

(54) BOOT FIRMWARE ACCESS

(71) Applicant: Intel Corporation, Santa Clara, CA (US)

(72) Inventors: Ramamurthy KRITHIVAS, Gilbert, AZ (US); Mahesh S. NATU, Folsom, CA (US); Eswaramoorthi NALLUSAMY, Cedar Park, TX (US); Tiffany J. KASANICKY, Longmont, CO (US)

(21) Appl. No.: 18/955,177

(22) Filed: Nov. 21, 2024

(51) Int. Cl. G06F 9/4401; G06F 9/50

(52) U.S. Cl. CPC G06F 9/4408; G06F 9/5044

(57) ABSTRACT

Examples described herein relate to allocating different lanes of an interface to different processor socket partitions and causing a processor socket partition to boot by accessing firmware by routing a request for the firmware to a device via one or more lanes of the interface and receiving the firmware from the one or more lanes. In some examples, the first host interface circuitry is to route an access to system address space for the first boot firmware to a particular lane of the first host interface circuitry.

### BACKGROUND

A computing system (e.g., server) can include multiple processor sockets that communicate with each other to increase available processor and cache and memory resources. For example, Intel® Xeon processor sockets can be connected in various configurations, such as 1 socket (1S), 2 socket (2S), 4 socket (4S), 8 socket (8S), or above 8S configurations. Cloud Service Providers (CSPs) and High Performance Computing (HPC) applications can utilize flexible socket partitioning to create isolated zones to dynamically operate a server in an 8S system setup with two isolated 4S zones (2×4S) or 4×2S, or other configurations, based on total cost of ownership (TCO), workload placement, or data center orchestrator planning.

### BRIEF DESCRIPTION OF THE DRAWINGS

FIG. 1 depicts an example system.

FIG. 2 depicts an example of socket partitioning.

FIG. 3 depicts an example of socket partitioning.

FIG. 4 depicts an example of socket partitioning.

FIG. 5 depicts an example process.

FIG. 6 depicts an example system.

### DETAILED DESCRIPTION

A central processing unit (CPU) utilizes numerous separate interfaces to access boot firmware or access or output time information, debug messages, and device and power management data. For example, the CPU accesses a Serial Peripheral Interface (SPI) interface to access a flash device for system on chip (SoC) and host firmware. For example, the CPU accesses an I2C interface to access time information based on Real-Time Clock (RTC). For example, the CPU accesses a Universal Asynchronous Receiver-Transmitter (UART) interface to output debug messages. For example, the CPU accesses General Purpose Input/Output (GPIO) pins to receive or output device and power management. For example, the CPU accesses eSPI, SMBUS, 13C, or Peripheral Component Interconnect express (PCIe) interface to output or receive debug and manageability data.

Where a processor socket is configured as sub-socket partitions, the sub-socket partitions can use separate interfaces. Replicating interfaces for different sub-socket partitions can increase a pin-count to an SoC or package tile. At least to attempt to reduce pins used to read boot firmware or read or write other data (e.g., debug information, manageability data), various examples described herein can allocate one or more lanes of an interface to read boot firmware or read or write other data. For example, where a processor socket is partitioned into an integer N number of partitions, the lanes of the interface can be allocated among the N partitions. For example, a PCIe root port can be utilized for at least one of the N number of partitions and the PCIe root port for a partition can utilize at least one of the lanes allocated to a partition to read boot firmware or read or write other data. For example, for a 2 sub-socket partition (A and B), an 8 lane PCIe interface can be allocated so that 4 lanes are allocated for use by sub-socket partition A and another 4 lanes are allocated for use by sub-socket partition B. For example, sub-socket partition A can utilize at least one of the 4 lanes to access boot firmware or read or write other data and sub-socket partition B can utilize at least one of the 4 lanes to access boot firmware or read or write other data.

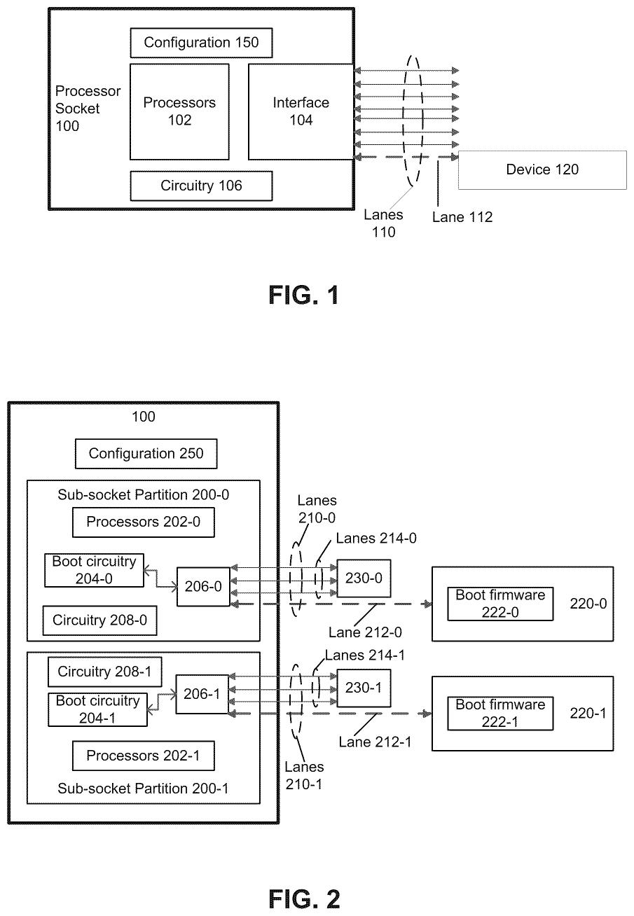

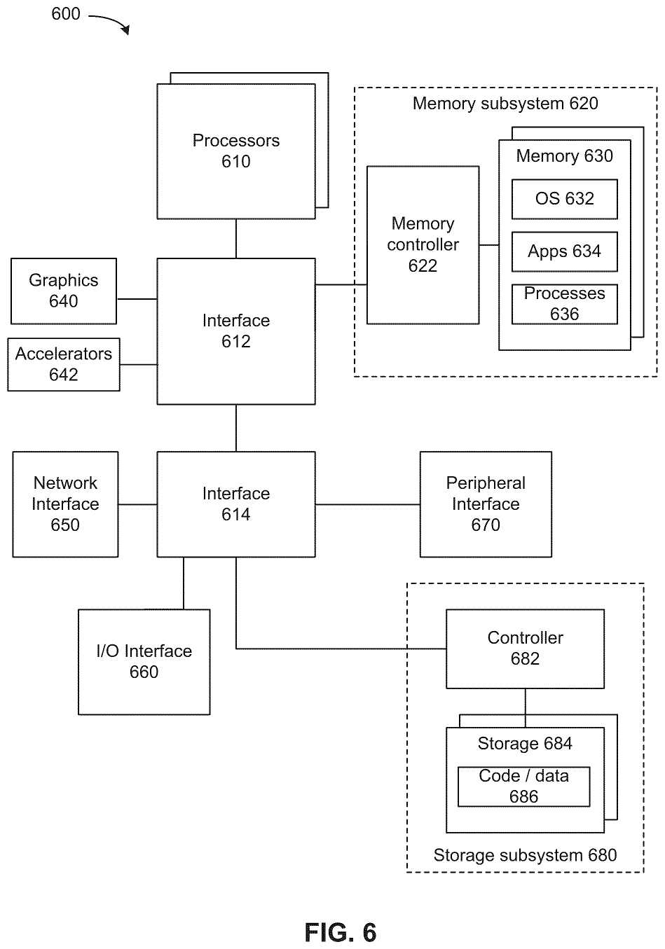

FIG. 1 depicts an example system. Socket 100 can include associated processors 102 and interface 104 as well as silicon firmware and other software or circuitry described at least with respect to FIG. 6. In some examples, socket 100 can include a cover that is made of plastic and can include metal contacts for pins or lands of processors 102. Processors with a pin grid array (PGA) or land grid array (LGA) package can be inserted into a socket. In some examples, socket 100 can include a physical package that includes one or more discrete dies or tiles connected by mesh or other connectivity as well as an interface (not shown) and heat dispersion (not shown). A die can include semiconductor devices that include one or more processing devices or other circuitry. A tile can include semiconductor devices that include one or more processing devices or other circuitry. For example, a physical package can include one or more dies, plastic or ceramic housing for the dies, and conductive contacts conductively coupled to a circuit board.

Processors 102 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processors 102 can be heterogeneous or homogeneous processor types where processors in different sockets are a same type (e.g., CPU, GPU, NPU, etc.) or different type. (e.g., a first socket includes a CPU and a GPU and a second socket includes a GPU and an NPU). Processors 102 can be implemented as bootable processors that include boot circuitry that can manage loading and execution of the firmware to boot processors 102 and circuitry 106.

Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

A system agent can include a shared cache which may include any type of cache (e.g., level 1, level 2, or last level cache (LLC)). A system agent can include or more of: a memory controller, a shared cache, a cache coherency manager, arithmetic logic units, floating point units, core or processor interconnects, or bus or link controllers. A system agent or uncore can provide one or more of: direct memory access (DMA) engine connection, non-cached coherent master connection, data cache coherency between cores and arbitrate cache requests, or Advanced Microcontroller Bus Architecture (AMBA) capabilities. System agent or uncore can manage priorities and clock speeds for receive and transmit fabrics and memory controllers.

Examples of firmware executed by circuitries 106 can include: security controller firmware, power management firmware, PCIe physical layer interface (Phy) firmware, display Phy firmware, manageability and telemetry firmware, memory controller (MRC) firmware, silicon initialization firmware, fabric power manageability agent (PMA) firmware that allocates power to circuitries and reports, memory subsystem (SS) firmware, graphics die PMA firmware, memory physical layer interface, security policy configuration data, configuration (config) data, or others.

In some examples, interface 104 can operate in a manner consistent at least with: SPI, eSPI, SMBUS, 13C, Infinity Fabric from Advanced Micro Devices, Inc. (AMD), AMD HyperTransport, NVIDIA® NVLink, Intel® QuickPath Interconnect (QPI), Advanced Microcontroller Bus Architecture (AMBA), Coherent Hub Interface (CHI) Chip to Chip (C2C), TileLink, RISC-V processor interconnect, Intel® Ultra Path Interconnect (UPI), Intel® On-Chip System Fabric (IOSF), Omnipath, Compute Express Link (CXL) (see, for example, Compute Express Link Specification revision 2.0, version 0.7 (2019), as well as earlier versions, later versions, and variations thereof), Peripheral Component Interconnect express (PCIe) (see, for example, Peripheral Component Interconnect (PCI) Express Base Specification 1.0 (2002), as well as earlier versions, later versions, and variations thereof), or other public or proprietary standards.

In some examples, interface 104 can operate as a PCIe root port (RP) to provide access through at least one of lanes 110 (e.g., lane 112) to device 120. One or more PCIe lanes can be allocated to fetch boot firmware for processors 102 or circuitry 106. For example, device 120 can include memory that stores boot firmware code and/or other data (e.g., debug information). Device 120 can be implemented as a management controller and/or non-volatile memory. A management controller can perform management and monitoring capabilities for system administrators to manage and monitor operation at least of a host and devices connected thereto, such as, network interface device and storage device, using channels, including channels that can communicate data (e.g., in-band channels) and out-of-band channels. Out-of-band channels can include packet flows or transmission media that communicate metadata and telemetry and may not communicate data. In some examples, management controller can be implemented as one or more of: Board Management Controller (BMC), Intel® Management or Manageability Engine (ME), or other devices.

At least to increase a capacity of boot firmware storage, device 120 can be used instead of or in addition to a SPI Flash device, to store and output firmware at boot or reset of processors 102 or circuitry 106. As described herein, depending on a number of sub-socket partitions (e.g., one, two, four, eight, and so forth), lanes of interface 104 (e.g., PCIe root-port) can be partitioned to provide one or more partitions with access to one or more of device 120. For example, configuration 150 can indicate a pin strap of how many sub-socket partitions are applied (e.g., 0, 2, 4, 8, or other values). Configuration of a processor socket into one or more partitions can occur by: instructions from a hypervisor, user input to a management console, direction from a server composition software, direction from a data center manager, a user input to a command line interface (CLI), a command from a management controller, or others. The management controller can configure the number of partitions in a socket via a GPIO. In some examples, such as for heterogeneous socket partitions, lane division may be unequal among different sockets. A number of lanes allocated to a socket partition can be configurable.

For example, two partitions can refer to two (e.g., 4×1, 4×1) root-ports. For example, four partitions can refer to four (e.g., 2×1, 2×1, 2×1, 2×1) root-ports. By partitioning lanes of interface 104 for different sub-socket partitions, a number of supportable partitions can increase without increasing a number of lanes. For example, a system on chip (SoC) can support zero or more sub-socket partitions with an infrastructure port with 8 lanes. One or more lanes that are not utilized to retrieve boot firmware or other data can be used for connectivity to a management controller, Video Graphics Array (VGA), memory, accelerator, or other devices. Other numbers of lanes for PCIe communications can be used. In some examples, one or more lanes allocated to access device 120 can be virtualized or shared for use to command, read, or write to devices.

In some examples, boot firmware code or firmware can include one or more of: Basic Input/Output System (BIOS), Universal Extensible Firmware Interface (UEFI), a boot loader, or microcode. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*. exe) files. This UEFI capsule can be deployed to a target platform as an SMM image via existing OS specific techniques (e.g., Windows Update for Azure, or LVFS for Linux).

SPI Flash access methods such as programmed input output (IO) and Flash linear addresses can utilize memory mapped input output (MMIO) cycles to access device 120. Using MMIO, a processor can access and control a hardware device by accessing memory addresses. Interface 104 can access architectural 128MB system address space, such as in a 4GB to 4GB-128MB range. In connection with fetching boot firmware arising at least from processor boot or reset, interface 104 can perform translation of flash linear address (FLA) (e.g., 24bit) accesses to PCIe semantics of MMIO (e.g., 32b/64b address) accesses. In some examples, the 128MB capacity can be expanded beyond 128MB by relocating the additional capacity window MMIO during boot or reset phases.

FIG. 2 depicts an example configuration. Based on configuration 250, processor socket 100 can be partitioned into partition 202-0 and partition 202-1 to logically partition a single processor package into two sub-socket nodes. Socket level partitioning allows a platform with multiple processor sockets to boot in a single system that executes a single operating system (OS) or multiple independent single socket systems that execute multiple operating systems. For example, in a non-partitioned mode, a 2S platform can operate as a single node, and resources connected to the two processor sockets are part of the single node. For instance, processor sockets (e.g., 200-0 and 200-1) in the non-partitioned mode can execute a single boot firmware (e.g., boot firmware stored in 220-0 or 220-1) and perform a handoff platform control to a single OS. Processors (e.g., 202-0 and 202-1) in the non-partitioned mode, including software (e.g., OS or processes) can share resources such as connected memory, cores in different sockets, cache, connected input/output (I/O), device interface-connected devices (e.g., Peripheral Component Interconnect express (PCIe), Compute Express Link (CXL)) and other circuitry, firmware, or software. Processors in the non-partitioned mode can access memory in a coherent manner so that memory is shared among the processors.

For example, in a partitioned mode, a 2S platform can operate as two separate sockets and can operate in independent power states (e.g., S0, S5, and so on), perform separate error handling, and not share one or more of: connected memory, cores in different sockets, cache, isolated input/output (I/O) communication interfaces, or device interface-connected devices.

Partitions can operate as separate coherent domains. Moreover, in partitioned mode, different socket partitions (e.g., 200-0 and 200-1) can independently power cycle, utilize different and independent clock signals, different partitions can utilize isolated in-band and out-of-band channels, different partitions can independently communicate with one or more management controllers, different partitions can utilize one or more debug ports, different partitions can independently utilize one or more root of trust devices that authenticate or validate different boot firmware, or others. Multiple processors (e.g., 202-0 and 202-1) can execute separate boot firmware code and handoff platform control to OSs executed by different processors. In a partitioned mode, peripheral or telemetry data may not be shared among different partitioned processor sockets, storage dependency may not be shared among different partitioned processor sockets, and so forth. In a partitioned mode, cross socket isolation can occur whereby sockets have independent power states. A catastrophic Reliability, Availability and Serviceability (RAS) event in a partition may not impact the run-time stability of another partitions.

For partitioned mode, bifurcation of resources (e.g., cache, memory, memory controllers, registers, processors, interfaces, physical layer interfaces, or others) among partitions may be equal or unequal and set based on service level agreement (SLA), service level objectives (SLO), application request, data center administrator configuration, or others.

In the partitioned mode, lanes 110 can be divided into lanes 210-0 and 210-1. Lanes 210-0 can be utilized for communication between partition 200-0 and storage 220-0 whereas lanes 210-1 can be utilized for communication between partition 200-1 and storage 220-1. For example, where lanes 110 include 8 lanes, lanes 210-0 can include 4 lanes and lanes 210-1 can include 4 lanes. In some examples lanes 210-0 include 4 PCIe lanes and lanes 210-1 include 4 PCIe lanes. One or more of lanes 210-0 can be utilized to communicate with storage 220-0 whereas one or more of lanes 210-1 can be utilized to communicate with storage 220-1. For example, interface 206-0 can access boot firmware 222-0 from storage 220-0 using lane 212-0. For example, interface 206-1 can access boot firmware 222-1 from storage 220-1 using lane 212-1.

At boot or reset of a processor, an example operation is as follows. At (1) bootable circuitry for a socket partition can access a Firmware Interface Table (FIT) table. A FIT is a data structure stored in the flash memory and includes multiple entries. An entry defines the starting address and attributes of different components in the BIOS or microcode. The address decoder in processors 202-0 or 202-1 can subtractively decode read or write of a memory address to a destination address associated with device 220-0 to 220-1. Subtractive decoding can include address decoding to a default address based on not matching with other addresses and routing read or writes to such addresses to a particular lane (e.g., lane 212-0 or 212-1). During a power up or power transition of interface 206-0 or 206-1, boot circuitry 204-0 or 204-1 can turn on the voltage regulator (VR) and phase locked loop (PLL) of a respective PCIe×1 lane (e.g., lane 212-0 or 212-1). In some examples, no PCIe training may be performed for lane 212-0 or 212-1 and no PCIe bus enumeration may be performed for this point-to-point link and a link can operate at a reduced speed. During a boot phase, the executed boot firmware can train the link to operate at a higher speed. During the reset sequence, processors 202-0 or 202-1 can issue PCIe MMIO Read or Write transactions instead of legacy SPI Read/Write cycles to fetch boot firmware.

In some cases, SPI Flash is used to hold the reset and boot firmware with SPI decode capacity of a maximum 256MB. An operating system (OS) or firmware can allocate system address space of 4GB to (4GB-128MB) to device 220-0 or 220-1 to store reset and boot firmware. Other sizes of memory address space can be allocated. The OS or firmware can allocate additional capacity X MB in MMIO from (4GB-128MB) to (4GB-128MB-X) during the reset firmware fetch phase. In some examples, two base address register (BAR) addresses can be allocated to device 220-0 or 220-1 such as a fixed and non-relocatable bar with 128MB size and another relocatable bar size X.

A non-relocatable BAR address region (e.g., 32b/64b PCIe BAR size) can be wired to 4G-128M range and boot and reset firmware allocated in this region. For the additional X MB capacity, a second relocatable BAR contiguous region (e.g., 32b/64b) can mapped to the (4G-XMB) to (4G-128MB) range initially out of reset. During boot phase, the boot firmware can relocate the relocatable BAR contiguous region to another region, with no impact to system address map. Various examples convert accesses to MMIO and can support more than 256MB capacity for boot firmware. During boot phase, boot firmware can relocate the MMIO to above MMIOH, and outside the range used by other PCIe devices.

For example, boot circuitry 204-0 can access boot firmware 222-0 from PCIe device via PCIe lane 212-0 by subtractively decoding MMIO read or write transactions for the legacy SPI Flash range of 4GB to (e.g., 4G-128M) and routing the MMIO read or write transactions to the configurable PCIe root port for device 220-0 for access using lane 212-0. Similarly, boot circuitry 204-1 can access boot firmware 222-1 from PCIe device via PCIe lane 212-1 by subtractively decoding MMIO read or write transactions for the legacy SPI Flash range of 4GB to (e.g., 4G-128M) and routing the MMIO read or write transactions to the configurable PCIe root port for device 220-1 using lane 212-1.

During a boot phase, boot circuitry 204-0 or 204-1 can retrieve and execute a microcode patch and/or boot firmware from a PCIe device (e.g., 220-0 or 220-1). Depending on the boot phase, the PCIe device maps boot firmware in a 128M MMIO address range. During a reset phase (e.g., post-cold, warm, or global reset), boot circuitry 204-0 or 204-1 can be released out of reset to fetch and execute their boot firmware (e.g., Startup Services Module (S3M), Out of Band Management Services Module (OOBMSM), etc.)

In some examples, storage 220-0 and/or storage 220-1 can be implemented as one or more of: management controller (e.g., BMC), non-volatile storage, cache, register, memory, or others.

Lanes 214-0 of lanes 210-0 can be utilized for communication with one or more devices 230-0. Lanes 214-1 of lanes 210-1 can be utilized for communication with one or more devices 230-1. One or more of devices 230-0 or 230-1 can include: management controller, an accelerator, graphics processing unit (GPU), memory, CPU, or other processor circuitry.

In some examples, virtualization technologies can be used to partition devices 230-0 or 230-1 to share access to virtualized peripheral devices among sockets. Peripheral devices can include one or more of: a network interface device, memory device, storage device, accelerator, or other circuitry. Various examples of virtualization technologies include Single Root I/O Virtualization (SR-IOV) and Intel® Scalable I/O Virtualization (SIOV). Single Root I/O Virtualization (SR-IOV) and Sharing specification, version 1.1, published Jan. 20, 2010 specifies hardware-assisted performance input/output (I/O) virtualization and sharing of devices. Intel® Scalable I/O Virtualization (SIOV) permits configuration of a device to group its resources into multiple isolated Assignable Device Interfaces (ADIs). Direct Memory Access (DMA) transfers from/to an ADI are tagged with a unique Process Address Space identifier (PASID) number. Unlike the device partitioning approach of SR-IOV to create multiple virtual functions (VFs) on a physical function (PF), SIOV enables software to flexibly compose virtual devices utilizing the hardware-assists for device sharing at finer granularity. An example technical specification for SIOV is Intel® Scalable I/O Virtualization Technical Specification, revision 1.0, June 2018, as well as earlier versions, later versions, and variations thereof.

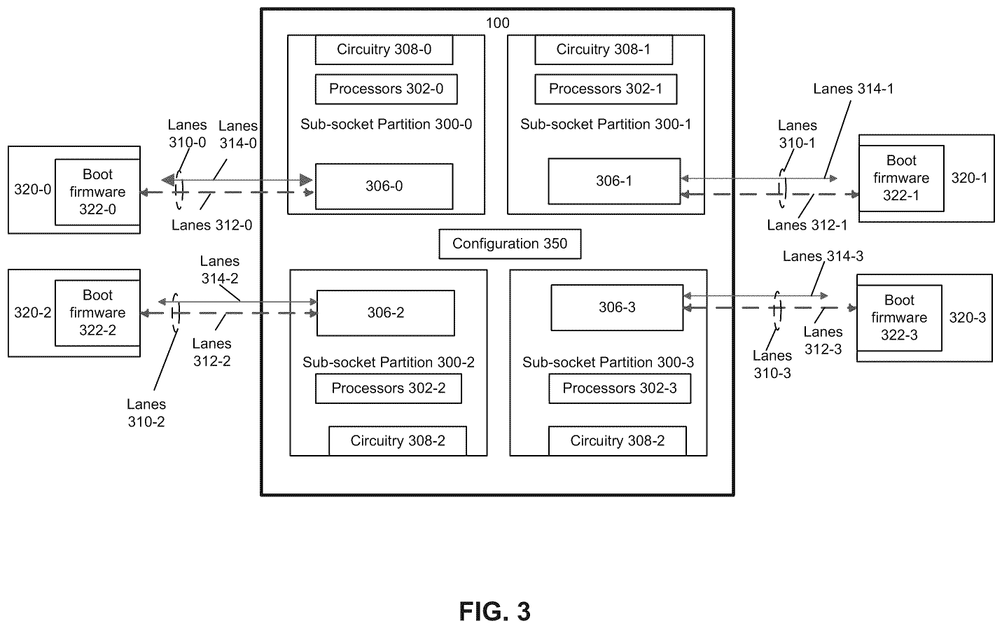

FIG. 3 depicts an example configuration. Processor socket 100 can logically partition a single processor package into four sub socket nodes into partition 300-0, partition 300-1, partition 300-2, and partition 300-3. Partitions 300-0 to 300-3 can be associated with respective processors 302-0 to 302-3. In this configuration, lanes 110 can be divided into lanes 310-0, 310-1, 310-2, and 310-3. Lane(s) 312-0 can be utilized for communication between partition 300-0 and storage 320-0, lane(s) 312-1 can be utilized for communication between partition 300-1 and storage 320-1, lane(s) 312-2 can be utilized for communication between partition 300-2 and storage 320-2, and lane(s) 312-3 can be utilized for communication between partition 300-3 and storage 320-3. Lanes 314-0 can be utilized for communication between partition 300-0 and other devices (e.g., 230-0 or the like), lanes 314-1 can be utilized for communication between partition 300-1 and devices (e.g., 230-1 or the like), lanes 314-2 can be utilized for communication between partition 300-2 and devices (e.g., 230-0 or the like), and lanes 314-3 can be utilized for communication between partition 300-3 and devices (e.g., 230-1 or the like).

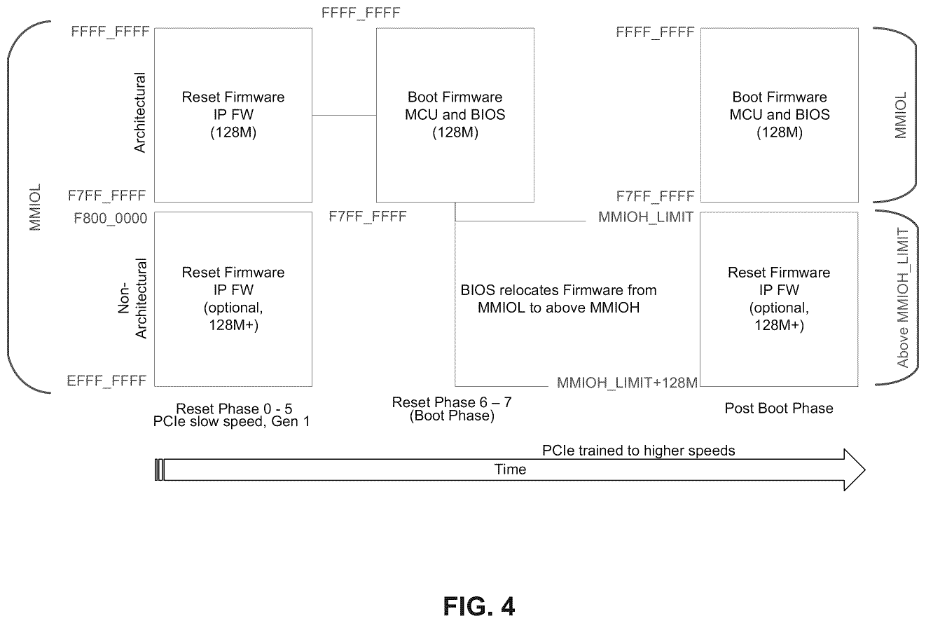

FIG. 4 depicts an example operation for a specific sub-socket partition from shutdown to working state (e.g., S5 to S0 transition). During reset phases 0-5 (Legacy system address 128M), firmware can be fetched via MMIO transactions instead of SPI Flash Linear address cycles. A FIT table can be accessed to discover respective firmware. Firmware fetch can occur via legacy SPI Linear address scheme in which case boot circuitry converts SPI Linear address into MMIO transactions.

During and/or after boot phase, boot firmware (e.g., BIOS) programs the BAR address of this range on the firmware storage device. The BIOS can relocate non-architectural firmware from MMIOL to above MMIOH_LIMIT in the system address space. During run-time, boot circuitry or a processor can access firmware and configuration updates.

At the end of the reset flow, boot circuitry or a processor can utilize a Security Protocol and Data Model (SPDM) protocol to establish an end-to-end encrypted link to fetch and execute the boot firmware image.

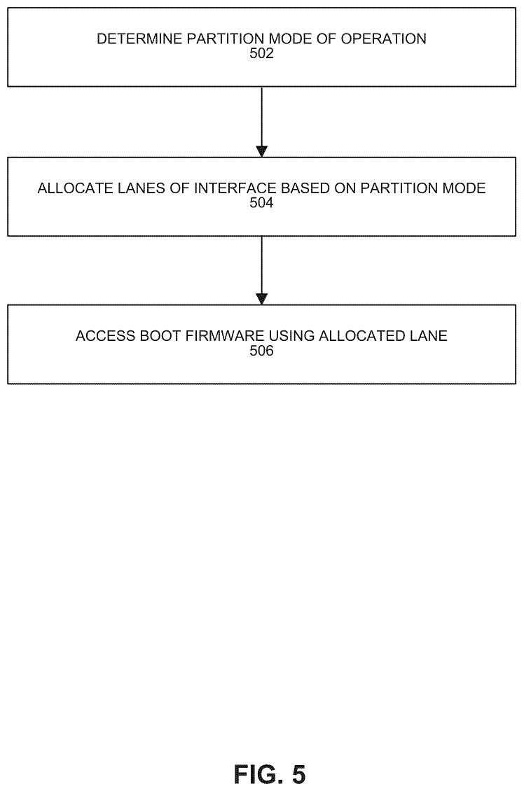

FIG. 5 depicts an example process. The process can be performed by a processor during link training and/or boot firmware during or after boot or reset. At 502, a determination can be made as to whether a processor socket operates in a partitioned mode or non-partitioned mode. The operation of the processor socket in partitioned mode or non-partitioned mode can be based on a configuration file or a pin strap configuration. At 504, based on processor boot or reset and partition mode, a processor socket can utilize one or more lanes of an interface to access boot firmware. The partitioning of lanes of the interface allocated to access boot firmware from one or more devices can be based on a partition mode. For example, for a non-partitioned, a single lane of the interface can be allocated to access boot firmware from one or more devices. For example, for two 4×1 partitions, two lanes of the interface can be allocated to access boot firmware from one or more devices for the two partitions. For example, for four 2×1 partitions, four lanes of the interface can be allocated to access boot firmware for the four partitions. At 506, the processor socket can access boot firmware using the allocated lane of the interface. The firmware can be executed by the processor or circuitry in an SoC.

FIG. 6 depicts a system. In some examples, processor sockets of system 600 (e.g., server, work station, node, or others) can be configured to access a boot firmware using a lane, as described herein. Various examples of a processor socket can include circuitry and software described with respect to FIG. 6. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes a first processor socket comprising a first processor, multiple boot circuitries, and multiple host interface circuitries, wherein: based on operation of the first processor socket in a partition mode to operate as a first partition and a second partition: a first boot circuitry of the multiple boot circuitries is associated with the first partition and a second boot circuitry of the multiple boot circuitries is associated with the second partition and based on a boot operation of the first partition, the first boot circuitry is to access first boot firmware from a first device by a first host interface circuitry of the multiple host interface circuitries.

Example 2 includes one or more examples, wherein: the first boot circuitry is to route

accesses to memory addresses associated with the first boot firmware to the first host interface circuitry.

Example 3 includes one or more examples, wherein the first host interface circuitry comprises a Peripheral Component Interconnect Express (PCIe) root port.

Example 4 includes one or more examples, wherein the first host interface circuitry is to route an access to system address space for the first boot firmware to a particular lane of the first host interface circuitry.

Example 5 includes one or more examples, wherein at least one lane of the first host interface circuitry is to provide connectivity with a second device, wherein the second device comprises one or more of: an accelerator, a storage interface, or a network interface device.

Example 6 includes one or more examples, wherein: based on a boot operation of the second partition, the second boot circuitry is to access second boot firmware from a second device by a second host interface circuitry of the multiple host interface circuitries.

Example 7 includes one or more examples, wherein: the second boot circuitry is to route accesses to memory addresses associated with the second boot firmware to the second host interface circuitry.

Example 8 includes one or more examples, and includes a second processor socket comprising a second processor, second multiple boot circuitries, and second multiple host interface circuitries and a second device that comprises a storage to store a second boot firmware, wherein: based on operation of the second processor socket in a partition mode to operate as a third partition and a fourth partition: a first boot circuitry of the second multiple boot circuitries is associated with the third partition and a second boot circuitry of the second multiple boot circuitries is associated with the fourth partition and based on a boot operation of the third partition, the first boot circuitry of the second multiple boot circuitries is to access the second boot firmware from the second device by a first host interface circuitry of the second multiple host interface circuitries.

Example 9 includes one or more examples, wherein: based on a reset of the first partition, the first boot circuitry is to access first boot firmware from the first device by the first host interface circuitry of the multiple host interface circuitries and based on a reset of the second partition, the second boot circuitry is to access second boot firmware from a second device by a second host interface circuitry of the multiple host interface circuitries.

Example 10 includes one or more examples, wherein the first boot firmware comprises one or more of: a Basic Input/Output System (BIOS), Universal Extensible Firmware Interface (UEFI), or a boot loader.

Example 11 includes one or more examples, and includes a process of making a processor socket comprising: coupling multiple boot circuitries to a processor socket and coupling multiple host interfaces to the processor socket, wherein: a first boot circuitry of the multiple boot circuitries is associated with a first partition of the processor socket, the first boot circuitry boots and resets by accessing first boot firmware via a request routed to a first host interface of the multiple host interfaces, a second boot circuitry of the multiple boot circuitries is associated with a second partition of the processor socket, the second boot circuitry boots and resets by accessing second boot firmware via a request routed to a second host interface of the multiple host interfaces.

Example 12 includes one or more examples, wherein the accessing the first boot firmware via the request routed to the first host interface of the multiple host interfaces comprises the first boot circuitry subtractively decoding an access to system address space to a particular lane of the first host interface.

Example 13 includes one or more examples, and includes: adjusting capacity to store boot firmware by adjusting memory mapped input output (MMIO) decoding.

Example 14 includes one or more examples, wherein the first host interface comprises a Peripheral Component Interconnect Express (PCIe) root port.

Example 15 includes one or more examples, wherein a second boot circuitry of the multiple boot circuitries is associated with a second partition of the processor socket and the second boot circuitry boots and resets by accessing second boot firmware via a request routed to a second host interface of the multiple host interfaces.

Example 16 includes one or more examples, and includes at least one non-transitory computer-readable medium comprising instructions stored thereon, that if executed by one or more processors, cause the one or more processors to: allocate different lanes of an interface to different processor socket partitions and cause a processor socket partition to boot by accessing firmware by routing a request for the firmware to a device via one or more lanes of the interface and receiving the firmware from the one or more lanes.

Example 17 includes one or more examples, and includes instructions stored thereon, that if executed by one or more processors, cause the one or more processors to: configure the one or more lanes to access the firmware from the device.

Example 18 includes one or more examples, and includes instructions stored thereon, that if executed by one or more processors, cause the one or more processors to: configure at least one of the lanes to access a second device.

Example 19 includes one or more examples, and includes instructions stored thereon, that if executed by one or more processors, cause the one or more processors to: configure the processor to access the firmware by routing memory mapped input output (MMIO) transactions to the device via the one or more lanes.

Example 20 includes one or more examples, wherein the firmware comprises one or more of: a Basic Input/Output System (BIOS), Universal Extensible Firmware Interface (UEFI), or a boot loader.

1. An apparatus comprising:
a first processor socket comprising a first processor, multiple boot circuitries, and multiple host interface circuitries, wherein:
based on operation of the first processor socket in a partition mode to operate as a first partition and a second partition:
a first boot circuitry of the multiple boot circuitries is associated with the first partition and a second boot circuitry of the multiple boot circuitries is associated with the second partition and
based on a boot operation of the first partition, the first boot circuitry is to access first boot firmware from a first device by a first host interface circuitry of the multiple host interface circuitries.

2. The apparatus of claim 1, wherein:
the first boot circuitry is to route accesses to memory addresses associated with the first boot firmware to the first host interface circuitry.

3. The apparatus of claim 1, wherein the first host interface circuitry comprises a Peripheral Component Interconnect Express (PCIe) root port.

4. The apparatus of claim 1, wherein the first host interface circuitry is to route an access to system address space for the first boot firmware to a particular lane of the first host interface circuitry.

5. The apparatus of claim 4, wherein at least one lane of the first host interface circuitry is to provide connectivity with a second device, wherein the second device comprises one or more of: an accelerator, a storage interface, or a network interface device.

6. The apparatus of claim 1, wherein:
based on a boot operation of the second partition, the second boot circuitry is to access second boot firmware from a second device by a second host interface circuitry of the multiple host interface circuitries.

7. The apparatus of claim 6, wherein:
the second boot circuitry is to route accesses to memory addresses associated with the second boot firmware to the second host interface circuitry.

8. The apparatus of claim 1, comprising:
a second processor socket comprising a second processor, second multiple boot circuitries, and second multiple host interface circuitries and
a second device that comprises a storage to store a second boot firmware, wherein:
based on operation of the second processor socket in a partition mode to operate as a third partition and a fourth partition:
a first boot circuitry of the second multiple boot circuitries is associated with the third partition and a second boot circuitry of the second multiple boot circuitries is associated with the fourth partition and
based on a boot operation of the third partition, the first boot circuitry of the second multiple boot circuitries is to access the second boot firmware from the second device by a first host interface circuitry of the second multiple host interface circuitries.

9. The apparatus of claim 1, wherein:
based on a reset of the first partition, the first boot circuitry is to access first boot firmware from the first device by the first host interface circuitry of the multiple host interface circuitries and
based on a reset of the second partition, the second boot circuitry is to access second boot firmware from a second device by a second host interface circuitry of the multiple host interface circuitries.

10. The apparatus of claim 1, wherein the first boot firmware comprises one or more of: a Basic Input/Output System (BIOS), Universal Extensible Firmware Interface (UEFI), or a boot loader.

11. A process of making a processor socket comprising:
coupling multiple boot circuitries to a processor socket and
coupling multiple host interfaces to the processor socket, wherein:
a first boot circuitry of the multiple boot circuitries is associated with a first partition of the processor socket,
the first boot circuitry boots and resets by accessing first boot firmware via a request routed to a first host interface of the multiple host interfaces,
a second boot circuitry of the multiple boot circuitries is associated with a second partition of the processor socket, and
the second boot circuitry boots and resets by accessing second boot firmware via a request routed to a second host interface of the multiple host interfaces.

12. The process of claim 11, wherein the accessing the first boot firmware via the request routed to the first host interface of the multiple host interfaces comprises the first boot circuitry subtractively decoding an access to system address space to a particular lane of the first host interface.

13. The process of claim 11, comprising: adjusting capacity to store boot firmware by adjusting memory mapped input output (MMIO) decoding.

14. The process of claim 11, wherein the first host interface comprises a Peripheral Component Interconnect Express (PCIe) root port.

15. The process of claim 11, wherein a second boot circuitry of the multiple boot circuitries is associated with a second partition of the processor socket and the second boot circuitry boots and resets by accessing second boot firmware via a request routed to a second host interface of the multiple host interfaces.

16. At least one non-transitory computer-readable medium comprising instructions stored thereon, that if executed by one or more processors, cause the one or more processors to:
allocate different lanes of an interface to different processor socket partitions and
cause a processor socket partition to boot by accessing firmware by routing a request for the firmware to a device via one or more lanes of the interface and receiving the firmware from the one or more lanes.

17. The at least one non-transitory computer-readable medium of claim 16, comprising instructions stored thereon, that if executed by one or more processors, cause the one or more processors to:
configure the one or more lanes to access the firmware from the device.

18. The at least one non-transitory computer-readable medium of claim 16, comprising instructions stored thereon, that if executed by one or more processors, cause the one or more processors to:
configure at least one of the lanes to access a second device.

19. The at least one non-transitory computer-readable medium of claim 16, comprising instructions stored thereon, that if executed by one or more processors, cause the one or more processors to:
configure the processor to access the firmware by routing memory mapped input output (MMIO) transactions to the device via the one or more lanes.

20. The at least one non-transitory computer-readable medium of claim 16, wherein the firmware comprises one or more of: a Basic Input/Output System (BIOS), Universal Extensible Firmware Interface (UEFI), or a boot loader.
